(19) United States
(12) Patent Application Publication
(10) Pub. No.: US 2008/0284785 A1
(43) Pub. Date: Nov. 20, 2008

(54) DYNAMIC DATA RATE DISPLAY

(75) Inventors: Daniel P. Axtman, Alta, WY (US); Benjamin A. Kendall, Boise, ID (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Kestrelink, Boise, ID (US)

(21) Appl. No.: 12/122,511

(22) Filed: May 16, 2008

Related U.S. Application Data
(60) Provisional application No. 60/938,414, filed on May 16, 2007.

(51) Int. Cl. G09G 5/36

(52) U.S. Cl. 345/545

(57) ABSTRACT

Dynamic data clock rate for data transfer to a display. The rate at which data is transferred from memory by a processor to a display is controlled such that data is transferred at or near one or more pixel refresh rates specified for the display while allowing at least one of the processor or memory to perform other tasks. A rate at which data is transferred from the processor to the display is reduced when the processor and/or memory is burdened with other tasks. When the processor and/or memory become more available as a result of reduction or elimination of other tasks, the rate at which data is transferred from the processor to the display is increased.

### CROSS-REFERENCE TO RELATED APPLICATIONS

The application claims the benefit of U.S. Provisional Application 60/938414 filed May 16, 2007, titled “DYNAMIC DATA RATE DISPLAY” which is incorporated herein by reference in its entirety.

### BACKGROUND

Background and Relevant Art

Computers and computing systems have affected nearly every aspect of modern living. Computers are generally involved in work, recreation, healthcare, transportation, entertainment, household management, etc. Computers can be used in embedded system to accomplish functionality in compact and specific applications. For example, a system may include an embedded processor, memory, and an LCD screen, where the processor is configured to transfer data from the memory to the screen so as to implement a digital picture frame application. In this and other display application, the timely clocking of pixel data to a digital interface of a display such as an LCD display is important to the performance and user acceptability of the LCD display. The rate at which the pixel data is clocked determines the level of stability of the displayed picture. If not clocked at a fast enough rate, the display will “flicker”.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment is directed to a method practiced in a computing environment. The computing environment includes a processor connected to a memory. At least one of the processor or memory drives a display, in addition to tasks other than driving the display. The method includes act for controlling the rate at which data is transferred by the processor to the display such that data is transferred at or near one or more pixel refresh rates specified for the display while allowing at least one of the processor or memory to perform other tasks. The pixel refresh rates define rates at which each pixel should be refreshed to control display flicker. The method includes reducing a rate at which data is transferred from the processor to the display. This includes reducing the data clock rate defining the rate at which data is provided to one pixel to when data is provided to the next pixel. This allows least one of the processor or memory to be used for other tasks. Reducing a rate at which data is transferred from the processor to the display may cause data to be transferred at a rate lower than a minimum data clock rate specified for the display to control display flicker if the reduced data clock rate were used as a constant data clock rate for the display. The method further includes, when additional processor and/or memory resources become available as a result of reduction or elimination of other tasks, increasing the rate at which data is transferred from the processor to the display. This includes increasing the data clock rate. Increasing the data clock rate includes increasing the data clock rate to a rate at or below a maximum data clock rate specified for the display and to a rate such that an actual pixel refresh rate for pixels in the display is at or near one or more pixel refresh rates specified for the display.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a block diagram including a processor, memory, and display device; and

FIG. 2 illustrates a timing chart illustrating timing of signals including the use of reduced and increased data clock rates.

### DETAILED DESCRIPTION

Many embedded system factors affect the ability of the system to maintain an acceptable data rate. Some of these factors include processor speed, memory access time, and display digital interface speed. To reduce cost, embedded systems for display applications, such as LCD applications, attempt to reduce the cost of memory and the cost of the processor(s). This usually means a slower processor and less memory.

As more functionality is required of the application executing on the processor (e.g. network connection, removable memory card access, remote control, image decoding, video decoding, etc.) the demands on the processor and memory access increases. As such, some processor and memory resources may be allocated to functions other than transferring data between the memory and the display. Consequently, if the processor is not able to transfer the pixel data to the LCD digital interface at a certain clock rate, “flicker” or data corruption or both can occur.

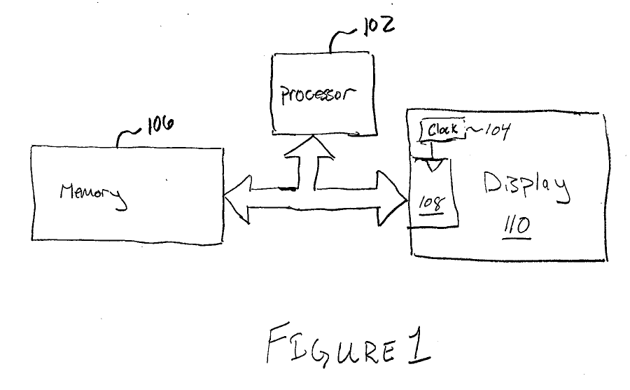

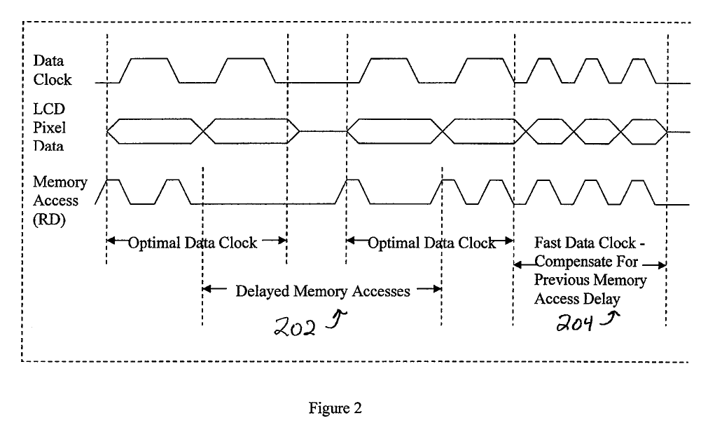

FIGS. 1 and 2 illustrate a design that uses a variable rate at which a data 104 clock controlling a digital interface 108 for a display 110 operates. In some embodiments, this may be used to reduce or eliminate the data corruption problem and the LCD “flicker” while allowing a low cost, slower processor 102 to be used, even during high memory demand (slower memory access times). For example, embodiments may be implemented where a rate at which data is transferred from the processor 102 to the display 110 is reduced when some or most of the processor or memory resources need to be allocated, or have been allocated to other tasks. Reducing the rate at which data is transferred may include reducing the data clock rate for the data clock 104 which defines the rate at which data is provided to each pixel. This allows at least one of the processor or memory to be used for other tasks. wherein reducing a rate at which data is transferred from the processor to the display may include intentionally causing data to be transferred at a rate lower than a minimum data clock rate specified in the manufacturer specifications for the display 110 to control display flicker if the reduced data clock rate were used as a constant data clock rate for the display.

Embodiments may further be implemented such that when processor and/or memory resources become more available as a result of reduction or elimination of other tasks, the rate at which data is transferred from the processor to the display is increased, such as by increasing the data clock rate. Increasing the data clock rate may include increasing the data clock rate to a rate at or below a maximum data clock rate specified in the manufacturer specifications for the display 110 to avoid data corruption. However, taking into account the reduction in rate previously performed, some embodiments may increase the rate to a rate such that an actual aggregate pixel refresh rate for pixels in the display when averaged over rate(s) for data for pixels delivered at the reduced rate(s) and rate(s) for data for pixels at the increased rate is at or near one or more pixel refresh rates specified for the display.

One embodiment allows the processor 102 to dynamically vary the rate of the data clock 108. The rate of the data clock 108 is controlled by the processor 102, based on the ability of the processor 102 to move the required pixel data from memory 106 to the display digital interface 108. When memory access is slow, the processor extends the data clock cycle, as illustrated at 202 of FIG. 2, essentially reducing the time between when data is provided from one pixel to the next pixel. In some embodiments, this is the time between adjacent pixels beginning to receive data. When memory access is fast, the processor 102 shortens the cycle of the data clock 104, essentially increasing the time between adjacent pixels receiving data. The data clock 104 may also be referred to as a dot clock.

In some embodiments, the processor 102 keeps the variable rate of the data clock 104 within at least the upper limits of the display digital interface 108 data clock specifications. The variable rate of the data clock 104 may, in some cases, be adjusted to less than the lower limits of the display digital interface 108 data clock specifications. This may facilitate the entire display 110, including all pixels in the display 110, being refreshed within or near the specified timing parameters of the display 110 to prevent or reduce flicker, but allows the processor to slow down or speed up individual pixel data transfers. The change in the cycle rate of the data clock 104 may be based on the refresh progress of the current frame and the immediate memory access availability of pixel data. In particular, an actual pixel refresh rate is targeted to a refresh rate specified for controlling flicker by attempting to comply with an overall frame refresh rate, such as a vertical refresh rate, while not being constrained to a constant data clock rate for each individual pixel of the frame. This allows for slower data clock rates to be used when immediate memory access is less available and faster data clock rates to be used when immediate memory access is more available.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, comprising a processor coupled to a memory, wherein at least one of the processor or memory drives a display, in addition to tasks other than driving the display, a method of controlling the rate at which data is transferred by the processor to the display such that data is transferred at or near one or more pixel refresh rates specified for the display while allowing at least one of the processor or memory to perform other tasks, the pixel refresh rates defining rates at which each pixel should be refreshed to control display flicker, the method comprising:
reducing a rate at which data is transferred from the processor to the display, including reducing the data clock rate defining the rate at which data is provided to one pixel to when data is provided to the next pixel, to allow at least one of the processor or memory to be used for other tasks, wherein reducing a rate at which data is transferred from the processor to the display may cause data to be transferred at a rate lower than a minimum data clock rate specified for the display to control display flicker if the reduced data clock rate were used as a constant data clock rate for the display; and
when processor and/or memory resources become more available as a result of reduction or elimination of other tasks, increasing the rate at which data is transferred from the processor to the display, including increasing the data clock rate, wherein increasing the data clock rate comprises increasing the data clock rate to a rate at or below a maximum data clock rate specified for the display, and to a rate such that an actual pixel refresh rate for pixels in the display is at or near one or more pixel refresh rates specified for the display.

2. The method of claim 1, wherein the processor directly drives the display.

3. The method of claim 1, wherein the display is an LCD.

4. The method of claim 1, wherein the method is implemented in a digital picture frame application.

5. The method of claim 1, wherein reducing a rate at which data is transferred from the processor to the display, includes reducing the data clock rate below a minimum data clock rate specified for the display.

6. The method of claim 1, wherein the processor and memory are used in a configuration other than a direct memory access (DMA) configuration for the display.

7. The method of claim 1, wherein at least one data clock rate is specified in terms of a pixel refresh rate and can be calculated based on the pixel refresh rate and the number of pixels in the display.

8. The method of claim 1, wherein tasks other than driving the display comprise network access tasks

9. The method of claim 1, wherein tasks other than driving the display comprise image decoding tasks.
